(19) United States
(12) Patent Application Publication
(10) Pub. No.: US 2017/0344586 A1
(43) Pub. Date: Nov. 30, 2017

(54) De-Duplication Optimized Platform for Object Grouping

(71) Applicant: International Business Machines Corporation, Armonk, NY (US)

(72) Inventors: M. Corneliu Constantinescu, San Jose, CA (US); Ramani R. Routray, San Jose, CA (US); Kensworth C. Subratie, Sunrise, FL (US)

(73) Assignee: International Business Machines Corporation, Armonk, NY (US)

(21) Appl. No.: 15/167,056

(22) Filed: May 27, 2016

(51) Int. Cl. G06F 17/30; G06N 7/00

(52) U.S. Cl. CPC G06F 17/30303; G06N 7/005; G06F 17/30138; G06F 17/30958

(57) ABSTRACT

Embodiments are provided for enhancing storage efficiency in a de-duplication enabled storage system. Metadata of a shared-nothing clustered file system is scanned, and a first state of the storage system is determined. One or more cores are located from the metadata. Each core includes a grouping of objects having a minimum coreness. An arrangement of the located cores is optimized to improve global de-duplication efficiency by evaluating the objects of each core, identifying respective nodes in the storage system to maintain each core for de-duplication efficiency based on the evaluation, and re-arranging one or more of the evaluated objects in the storage system.

### BACKGROUND OF THE INVENTION

### Technical Field

The embodiments described herein relate to object groupings in data storage. More specifically, the embodiments relate to a platform for object grouping that enhances de-duplication in a clustered environment.

### Description of the Prior Art

Object placement may be a critical decision made in a distributed computing architecture, such as one employing a clustered disk based filesystem. The placement of objects, such as files, blocks, volumes, etc., on disks may be based on filesystem configuration parameters. In one embodiment, the distributed computing architecture employs a shared nothing clustered disk based filesystem, hereinafter referred to as a shared nothing clustered filesystem where each node is independent and self-sufficient. In one embodiment, the nodes in a shared nothing clustered filesystem do not share memory or disk storage. Accordingly, the shared nothing framework eliminates points of contention or failure between system components.

It is understood that objects from different nodes in the shared nothing clustered filesystem may need to be shared, such as when an external system queries information from different nodes simultaneously within the shared nothing clustered filesystem. Sharing of objects may result in duplication of the objects. Data reduction methods, such as de-duplication, may be implemented to save storage space within storage systems. De-duplication, as is known in the art, is a process performed to eliminate redundant data objects, which may also be referred to as chunks, blocks, or extents within a de-duplication enabled storage system. Generally, filesystems assume object-independence in performing tasks, allowing the filesystem to independently manage objects without affecting other objects. At the same time, de-duplication introduces constraints, such as content sharing among objects and externalities. These externalities may include filesystem constraints such as disk capacity and migration cost. In a shared-nothing filesystem, de-duplication introduces additional constraints and challenges to storage management as filesystem tasks may no longer view objects as independent. Accordingly, content sharing is a factor in optimizing object storage efficiency in the filesystem.

### SUMMARY OF THE INVENTION

The aspects described herein include a system, computer program product, and method for enhancing storage efficiency in a de-duplication enabled storage system.

According to one aspect, a shared-nothing clustered file system is provided. The system includes a processing unit in communication with memory. One or more tools are in communication with the processor and function to scan metadata of the file system, and to determine a first state of the file system. One or more cores are located from the metadata. Each core includes a grouping of objects having a minimum coreness. An arrangement of the located cores is optimized to improve global de-duplication. The optimization includes an evaluation of the objects of each core, identification of respective nodes in the storage system to maintain each core for de-duplication efficiency based on the evaluation, and re-arrangement pf one or more of the evaluated objects in the storage system.

According to another aspect, a computer program product is provided to enhance storage efficiency in a de-duplication enable storage system. The computer program product includes a computer-readable storage device having computer-readable program code embodied therewith. The program code is executable by a processor to scan metadata of a shared-nothing clustered file system, and determine a first state of the file system. One or more cores are located from the metadata scan. Each core includes a grouping of objects having a minimum coreness. An arrangement of the located cores is optimized to improve global de-duplication by evaluating the objects of each core, identifying respective nodes in the storage system to maintain each core for de-duplication efficiency based on the evaluation, and re-arranging one or more of the evaluated objects in the storage system.

According to yet another aspect, a method is provided for enhancing storage efficiency in a de-duplication enable storage system. Metadata of a shared-nothing clustered file system is scanned, and a first state of the file system is determined. One or more cores are located from the metadata. Each core includes a grouping of objects having a minimum coreness. An arrangement of the located cores is optimized to improve global de-duplication by evaluating the objects of each core, identifying respective nodes in the storage system to maintain each core for de-duplication efficiency based on the evaluation, and re-arranging one or more of the evaluated objects in the storage system.

Other features and advantages of will become apparent from the following detailed description of the presently preferred embodiments, taken in conjunction with the accompanying drawings.

### BRIEF DESCRIPTION OF THE DRAWINGS

The drawings referenced herein form a part of the specification. Features shown in the drawing are meant as illustrative of only some of the embodiments, and not of all of the embodiments unless otherwise explicitly indicated. Implications to the contrary are otherwise not to be made.

FIG. 1 depicts a block diagram illustrating an exemplary storage system.

FIG. 2 depicts a flowchart illustrating a process for improving global de-duplication efficiency in a shared-nothing clustered storage system.

FIG. 3 depicts a diagram illustrating an exemplary content sharing graph.

FIG. 4 depicts a a flowchart illustrating a process of managing a new object.

FIG. 5 depicts a block diagram illustrating an example of a computer system/server configured to optimize storage efficiency in a de-duplication enable storage system.

FIG. 6 depicts a cloud computing environment.

FIG. 7 depicts a block diagram illustrating a set of functional abstraction model layers provided by the cloud computing environment.

### DETAILED DESCRIPTION

It will be readily understood that the components, as generally described and illustrated in the Figures herein, may be arranged and designed in a wide variety of different configurations. Thus, the following detailed description of the embodiments of the apparatus, system, and method, as presented in the Figures, is not intended to limit the scope of the claims, but is merely representative of select embodiments.

The functional units described in this specification have been labeled as a profile manager, a layout manager, and a garbage collection manager, which may collectively be referred to as managers or tools. The managers may be implemented in programmable hardware devices such as field programmable gate arrays, programmable array logic, programmable logic devices, or the like. The managers may also be implemented in software for processing by various types of processors. An identified manager of executable code may, for instance, comprise one or more physical or logical blocks of computer instructions which may, for instance, be organized as an object, procedure, function, or other construct. Nevertheless, the executables of an identified manager need not be physically located together, but may comprise disparate instructions stored in different locations which, when joined logically together, comprise the manager and achieve the stated purpose of the manager.

Indeed, a manager of executable code could be a single instruction, or many instructions, and may even be distributed over several different code segments, among different applications, and across several memory devices. Similarly, operational data may be identified and illustrated herein within the manager, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of an analysis manager, a recommendation manager, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

A core is a group of objects, such as files, that share some content. In one embodiment, the core is measured in bytes. Coreness is associated with a set of objects. Namely, coreness is the size of shared content in the core, which in one embodiment is measured in bytes. As such, the core is a group of objects having a minimum coreness, e.g. a minimum number of shared bytes. Since each object in a core can have a different coreness, an extracted coreness is in reference to an object.

The system shown and described herein is labeled with tools to support and enable object de-duplication in a shared nothing clustered filesystem. More specifically, the tools employ object characteristics pertaining to core and coreness with object de-duplication. The tools may be implemented in programmable hardware devices such as field programmable gate arrays, programmable array logic, programmable logic devices, or the like. The tools may also be implemented in software for processing by various types of processors. An identified manager of executable code may, for instance, comprise one or more physical or logical blocks of computer instructions which may, for instance, be organized as an object, procedure, function, or other construct. Nevertheless, the executables of an identified tool need not be physically located together, but may comprise disparate instructions stored in different locations which, when joined logically together, comprise the tool and achieve the stated purpose of the tool.

Indeed, a tool in the form of executable code could be a single instruction, or many instructions, and may even be distributed over several different code segments, among different applications, and across several memory devices. Similarly, operational data may be identified and illustrated herein within the tool, and may be embodied in any suitable form and organized within any suitable type of data structure. The operational data may be collected as a single data set, or may be distributed over different locations including over different storage devices, and may exist, at least partially, as electronic signals on a system or network.

A shared-nothing architecture is a distributed computing architecture in which each node is independent and self-sufficient. More specifically, each node includes one or more processors, main memory and data storage, and communicates with other nodes through an interconnection network. Each node is under the control of its own copy of the operating system and can be viewed as a local site in a distributed database system. The nodes do not share memory or data storage.

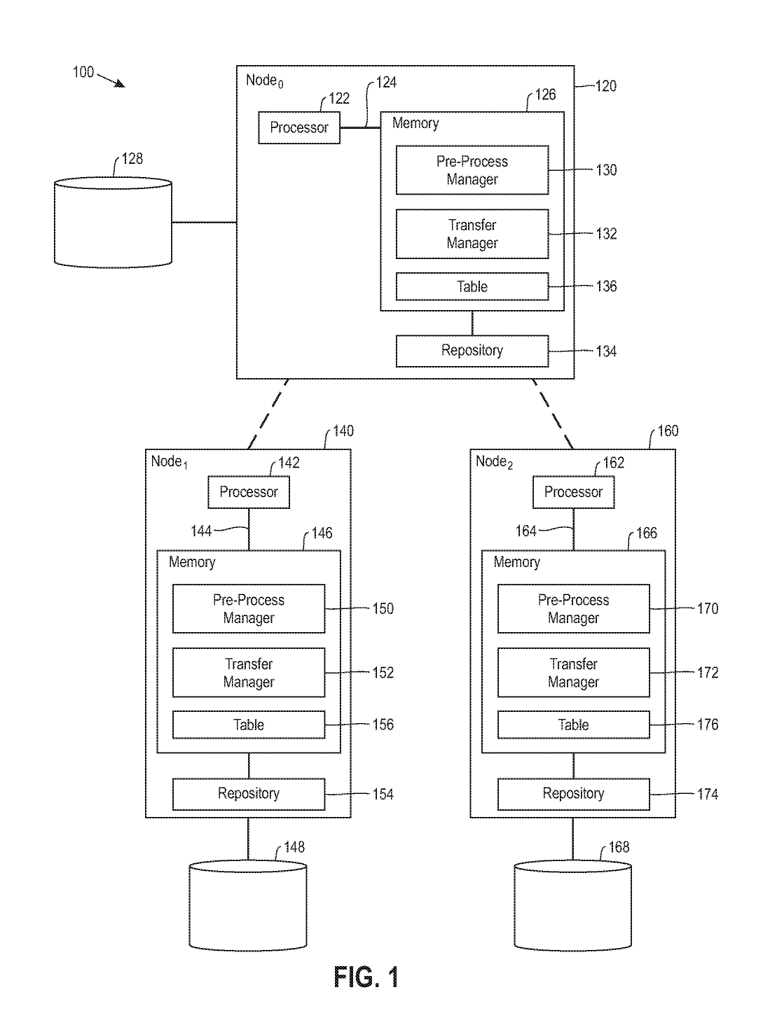

With reference to FIG. 1, a block diagram is provided illustrating an exemplary shared-nothing architecture (100) that also functions as a de-duplication enabled storage system, such as a shared-nothing clustered disk based filesystem. As shown, the system (100) includes three server nodes (120), (140), and (160), also referred to herein as nodes. Each node has at least one processor in communication with memory, and local data storage. As shown, node₀ (120) has a processor (122) in communication with memory (126) across a bus (124), and is further shown with persistent storage (128). Similarly, node₁ (140) has a processor (142) in communication with memory (146) across a bus (144), and is further shown with persistent storage (148), and node₂ (160) has a processor (162) in communication with memory (166) across a bus (164), and is further shown with persistent storage (168). Although each node is shown with local persistent storage, it is understood that data storage may be local or remote, and that each node may have additional data storage components and the storage units shown herein are for illustrative purposes. In one embodiment, one or more of the persistent storage elements shown herein may be remote from the node and accessible across a network connection. Regardless of the location of the persistent storage, it retains the characteristics of persistent storage in a shared-nothing architecture.

Each node in the architecture includes one or more tools to support the de-duplication. As shown herein, each node includes a pre-processing manager and a transfer manager. More specifically, node₀ (120) is shown with pre-processing manager (130) and transfer manager (132), node₁ (140) is shown with pre-processing manager (150) and transfer manager (152), and node₂ (160) is shown with pre-processing manager (170) and transfer manager (172). Each node maintains a repository, e.g. database, with de-duplication metadata. As shown herein, node₀ (120) maintains repository (134), node₁ maintains repository (154), and node₂ maintains repository (174). The repository local to each node retains de-duplication metadata, including but not limited to file chunk sizes, location, and hash values, associated with objects in the associated local data storage. In one embodiment, the pre-processing tool assesses the objects, with the pre-processing chunking the files, creating hash values, and maintaining a file to hash mapping. Based on the pre-processing, objects local to each node are organized into cores with each core having an associated coreness. De-duplication of data may take place local to each node, with a de-duplicated size of a core being the sum of the object sizes in the core where the shared content is only considered once.

In one embodiment, each node may retain a table to organize objects and identify associated cores and object coreness. The following is an example of the table:

TABLE 1

| | | | |
|---|---|---|---|
| Object₀ | Hash₀ | Coreness₀ | Core Assignment |
| Object₁ | Hash₁ | Coreness₁ | Core Assignment |
| Object₂ | Hash₂ | Coreness₂ | Core Assignment |
| Object₃ | Hash₃ | Coreness₃ | Core Assignment |

In a shared-nothing filesystem, the objects of each node are de-duplicated on a node-basis. As shown in this figure, the table is maintained for each node, with the content of the table related to the associated node. More specifically, node₀ (120) is shown with table₀ (136) local to memory (126), node₁ (140) is shown with table₁ (156) local to memory (146), and node₂ (160) is shown with table₂ (176) local to memory (166). In the example shown herein, the table is shown local to memory, although the location of the table with respect to the associated node should not be considered limiting. Accordingly, de-duplication data for each node is created and retained in conjunction with the associated coreness and core assignment.

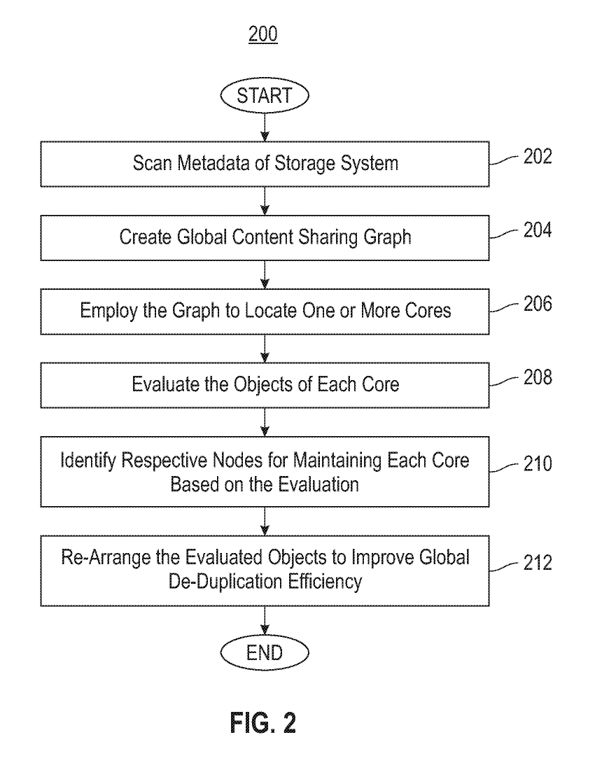

The aspect of deriving core and associated coreness of objects is employed herein and is retained in the repository local to the individual nodes. With reference to FIG. 2, a flowchart (200) is provided illustrating a method for improving global de-duplication efficiency in a shared-nothing clustered storage system. De-duplication is a data technique for reducing the amount of storage space for data storage. More specifically, de-duplication eliminates duplicate copies of data by saving one copy of the data and replacing other copies with pointers that lead back to the original copy. This de-duplication may be local to a single storage system, or in one embodiment, expanded to a clustered storage system, which is referred to as global de-duplication.

As discussed above and shown in FIG. 1, in a shared-nothing clustered file system repositories of de-duplication metadata are maintained local to respective nodes of the storage system. In one embodiment, the de-duplication metadata is maintained in tables in each node. Similarly, in one embodiment, each table may reside in memory local to the respective node. The de-duplication metadata may include object-to-chunk mapping containing information such as file chunk sizes and locations, hash values, etc. The de-duplication metadata of the one or more locally maintained repositories is scanned (202), and a global content sharing graph is created based on the scan (204). In one embodiment, the scan at step (202) is an offline periodic scan of the one or more locally maintained repositories of de-duplication metadata. The global content sharing graph created at step (204) supports global de-duplication.

As shown in Table 1, each object has a hash value. To create the global content sharing graph at step (204), each of the locally maintained repositories of de-duplication metadata is visited. Content sharing between objects of the storage system is determined based on the de-duplication metadata by traversing each object and collecting a “trace”. In one embodiment, the trace may be a sequence of content hash values for each object, with each hash associated with a respective object chunk. Accordingly, de-duplicated file metadata, such as the hash value and the trace, may be used to identify objects that share content in order to create a global content sharing graph in support of cumulating both intra-node and inter-node de-duplications.

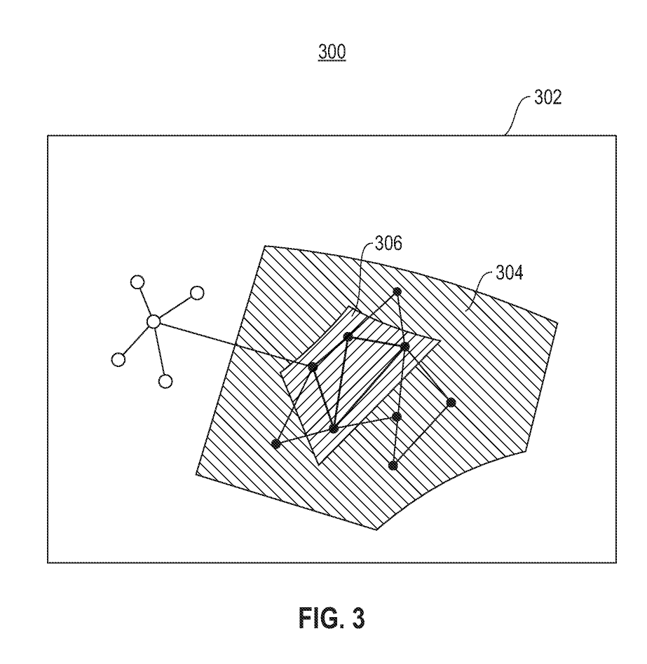

An example of a global content sharing graph is shown and described in FIG. 3. The global content sharing graph is represented as a directed acyclic graph (DAG) comprised of vertices and edges. Each vertex of the global content sharing graph corresponds to an object (e.g., a file). Edges of the global content sharing graph represent a sharing of content between adjacent vertices. In one embodiment, object identifier data is assigned to each vertex corresponding to its respective object. To minimize the number of edges of the graph, shared content is represented once, and each edge has a weight measure (i.e., coreness) associated with a quantity of total bytes shared between adjacent vertices. In one embodiment, the coreness is derived by traversing the global content sharing graph. The traversal is performed in near linear time based on the number of vertices. In one embodiment, the time of traversal is proportional to the number of nodes or objects in the system. Each content sharing graph is designed to be small, scalable, and memory resident. Accordingly, the global content sharing graph models content sharing between objects, such as files.

One or more cores are located within the global content sharing graph (206). Each core includes a grouping of objects having a minimum coreness. In one embodiment, each core is a k-core of the global content sharing graph. Generally speaking, a k-core of a graph is a maximal connected subgraph in which each vertex is adjacent to at least k other vertices (i.e., each vertex has at least degree k). As applied here, the weight of each edge is used to group the vertices in each k-core. Specifically, a k-core herein represents a maximal connected subgraph of the content sharing graph, such that each vertex shares a total of at least k bytes among its adjacent vertices (i.e., each vertex of a k-core has a minimum coreness value k). Accordingly, each k-core may be viewed as a sub-collection of objects represented by the content sharing graph.

With reference to FIG. 3, an exemplary content sharing graph (300) is provided with an accompanying k-core decomposition. The graph (300) includes a plurality of vertices, with adjacent vertices connected by edges. Each edge indicates a qualitative relationship between the connected vertices. In one embodiment, weight data, or coreness, may be maintained to represent a quantitative data sharing relationship between vertices connected by an edge. For instance, the weight data may indicate a quantity of total bytes shared between the objects represented by the vertices.

In this illustrative example, the graph (300) is decomposed into three k-cores, namely a 1-core (302), a 2-core (304), and a 3-core (306). In this example, each k-core includes vertices having a minimum of k connections. The 1-core (302) is a maximal connected subgraph of graph (300) that includes all the vertices of graph (300) having at least one adjacent vertex, the 2-core (304) is a maximal connected subgraph of graph (300) that includes all vertices having at least two adjacent vertices, and the 3-core (306) is a maximal connected subgraph of graph (300) that includes all the vertices of graph (300) having at least three adjacent vertices. However, as discussed above, a k-core as applied here represents a maximal connected subgraph of a content sharing graph, such that each vertex shares a total of at least k bytes among its adjacent vertices. Typically, due to positioning, vertices nearer to the center of the content sharing graph will have higher coreness values. Generally, higher degree cores are nested subsets of lower degree cores. For instance, as seen in FIG. 3, 3-core (306) is nested within 2-core (304), which is nested in 1-core (302). Accordingly, each vertex will belong to its core, along with any other lower degree cores of the content sharing graph.

Modeling the objects of the filesystem as a global content sharing graph may be used to address challenges in storage management associated with shared nothing de-duplication. For example, the global content sharing graph may be used optimize an arrangement of objects and/or cores within the storage system to improve global de-duplication efficiency. Referring back to FIG. 2, following pre-processing steps (202)-(206), the objects of each core are evaluated (208), and respective nodes in the storage system are identified for maintaining each core based on the evaluation (210). After the evaluation and identification at steps (208) and (210), one or more of the evaluated objects may be re-arranged in the storage system (212). That is, at least one object may be transferred from its current node for placement on another node.

Placing objects together through the re-arrangement at step (212) further contributes to de-duplication on an inter-node basis and, in one embodiment, improves global de-duplication efficiency (i.e., increases the efficiency of performing data de-duplication within the storage system). If objects forming a high sharing k-core (i.e., a core having a large k value) happen to be in different nodes, the objects would have to be placed in the same node (if possible) subject to constraints such as available node capacities, available bandwidth, and overall migration cost. In one embodiment, the re-arrangement at step (212) includes a migration of objects to produce a highest improvement in the overall de-duplication. The global de-duplication in the shared nothing clustered file system brings efficiency into data storage by storing the data and reference to the data local to the same node. More specifically, the transfer of the data in the shared-nothing environment reduces duplication of the data on an inter-node basis. Accordingly, a de-duplication based graph model is employed to dynamically manage an arrangement of objects within a de-duplication enabled storage system to improve global de-duplication efficiency.

In one embodiment, the node arrangement and associated storage may be organized in a hierarchy, with the re-arrangement at step (212) including a migration of the one or more objects between tiers of the storage system. In a traditional tiered storage system, data is categorized (e.g., based on performance, availability, and/or recovery requirements) and assigned to respective storage tiers based on the characterization. An object within the tiered storage system may be dynamically promoted or demoted based on a characterization change. For example, if the tiered storage system includes at least a primary tier and a secondary tier, an object characterized as “old” (e.g., determined to not have been used recently) residing in the primary tier may be subject to a demotion from the primary tier to the secondary tier. In a traditional tiered storage system, the demotion of the old object may include a migration from the primary tier to the secondary tier without affecting other files. However, in a de-duplicated tiered storage system, the old object may share content with one or more other objects. Thus, optimal migration of the old object takes into account any other objects within the storage system that share content with the old object. As discussed above, content sharing between objects may be modeled by a global content sharing graph and a subsequent analysis of a k-core decomposition of the graph. Accordingly, the implementation of the global content sharing graph and k-core analysis may improve global de-duplication efficiency with respect to object placement between tiers of a tiered storage system

As discussed above, the metadata scan performed on the storage system may be implemented periodically to dynamically re-arrange objects. If a subsequent scan of the de-duplication metadata determines that a “new object” is present in the storage system, new object selection and placement may be strategic to improve global de-duplication efficiency. As used herein, the term “new object” may be defined as an object that is determined to be unassigned during a current scan of the storage system. In other words, a new object may be an object that was not previously assigned to a core (i.e., was not previous associated with a previous state of the storage system). For example, the new object may be an individual incoming file.

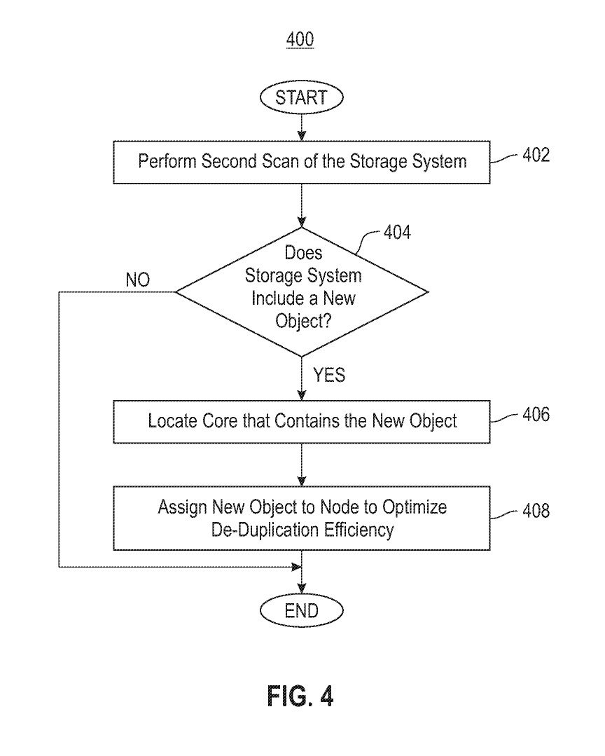

With reference to FIG. 4, a flowchart (400) is provided illustrating a process of managing a new object. A scan of the storage system is performed (402), and it is determined if the storage system includes a “new object” (404). A negative response to the determination at step (404) indicates that there are no new objects that need to be assigned to a node. However, an affirmative response to the determination at step (404) is an indication that there is a new object that requires placement on a node. A core for placement of the object is selected (406), and the new object is assigned to a node associated with the identified core to optimize de-duplication efficiency (408). In one embodiment, the selection at step (408) includes employing an inline probabilistic similarity estimation technique to locate an optimal core, and the new object is assigned to the node associated with the located core. The purpose of the inline probabilistic similarity estimation technique is to locate a better-than-random placement for new objects so that a larger re-arrangement or migration of objects may be avoided (or delayed). The inline probabilistic similarity estimation technique may employ a de-duplication map to locate the optimal node for placement of the new object. In one embodiment, the inline probabilistic similarity estimation technique utilizes a hashing scheme, such as MinHash or SimHash. As known in the art, MinHash and SimHash are techniques used to provide a quick estimate of the similarity of two sets. Similarly, in one embodiment, the a global content sharing graph may be utilized in conjunction with or independent of the estimation technique for optimizing object placement in a de-duplication enabled storage system. Accordingly, object assignment and placement within the shared-nothing clustered file system is strategic to support de-duplication efficiency.

The processes of FIGS. 2 and 4 optimize object placement on nodes in a de-duplication enabled storage system based on an analysis of content sharing between objects of the storage system. Specifically, one or more groupings of content sharing objects, or cores, are located and their objects are evaluated to identify optimal nodes on the storage system for storage of each core to improve global de-duplication efficiency. One or more objects may be re-arranged, such as by migration between nodes of the storage system, in order to place objects of a core on the same node.

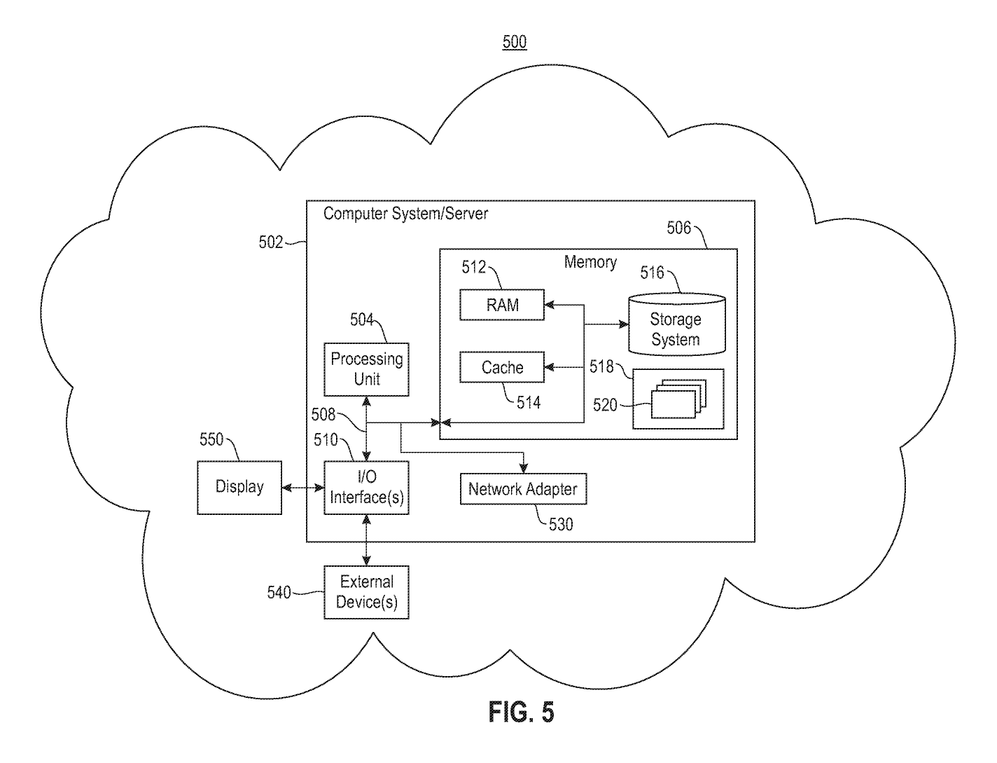

The processes of FIGS. 2 and 4 may be implemented via tools of a computer system. With reference to FIG. 5, a block diagram (500) is provided illustrating an example of a computer system/server (502), hereinafter referred to as a node (502), that is configured to optimize storage efficiency in a de-duplication enable storage system in accordance with the embodiments described above. Node (502) is operational with numerous other general purpose or special purpose computing system environments or configurations. Examples of well-known computing systems, environments, and/or configurations that may be suitable for use with node (502) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and filesystems (e.g., distributed storage environments and distributed cloud computing environments) that include any of the above systems or devices, and the like.

Node (502) may be described in the general context of computer system-executable instructions, such as program modules, being executed by a computer system. Generally, program modules may include routines, programs, objects, components, logic, data structures, and so on that perform particular tasks or implement particular abstract data types. Node (502) may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, node (502) is shown in the form of a general-purpose computing device. The components of node (502) may include, but are not limited to, one or more processors or processing units (504), a system memory (506), and a bus (508) that couples various system components including system memory (506) to processor (504). Bus (508) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Node (502) typically includes a variety of computer system readable media. Such media may be any available media that is accessible by node (502) and it includes both volatile and non-volatile media, removable and non-removable media.

Memory (506) can include computer system readable media in the form of volatile memory, such as random access memory (RAM) (512) and/or cache memory (514). Node (502) further includes other removable/non-removable, volatile/non-volatile computer system storage media. By way of example only, storage system (516) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (408) by one or more data media interfaces. As will be further depicted and described below, memory (506) may include at least one program product having a set (e.g., at least one) of program modules that are configured to carry out the functions of the embodiments described above with reference to FIGS. 1-4.

Program/utility (518), having a set (at least one) of program modules (420), may be stored in memory (506) by way of example, and not limitation, as well as an operating system, one or more application programs, other program modules, and program data. Each of the operating systems, one or more application programs, other program modules, and program data or some combination thereof, may include an implementation of a networking environment. Program modules (520) generally carry out the functions and/or methodologies of embodiments as described herein. For example, the set of program modules, or tools (520) may include one or more tools that are configured to scan a repository of de-duplication metadata local to the node (502) in order to locate one or more cores from the de-duplication metadata, as described above with reference to FIGS. 1-4. The tools (520) are further configured to optimize an arrangement of the located cores. The optimization includes the tools (520) to evaluate the objects of each core, identify respective nodes in the storage system to maintain each core for de-duplication efficiency based on the evaluation, and re-arrange one or more of the evaluated objects to improve global de-duplication efficiency, as described above with reference to FIGS. 1-4.

Node (502) may also communicate with one or more external devices (440), such as a keyboard, a pointing device, etc.; a display (550); one or more devices that enable a user to interact with node (502); and/or any devices (e.g., network card, modem, etc.) that enable node (502) to communicate with one or more other computing devices. Such communication can occur via Input/Output (I/O) interface(s) (510). Still yet, node (502) can communicate with one or more networks such as a local area network (LAN), a general wide area network (WAN), and/or a public network (e.g., the Internet) via network adapter (530). As depicted, network adapter (530) communicates with the other components of node (502) via bus (508). In one embodiment, a filesystem, such as a distributed storage system, may be in communication with the node (502) via the I/O interface (510) or via the network adapter (530). It should be understood that although not shown, other hardware and/or software components could be used in conjunction with node (502). Examples, include, but are not limited to: microcode, device drivers, redundant processing units, external disk drive arrays, RAID systems, tape drives, and data archival storage systems, etc.

In one embodiment, node (502) is a node of a cloud computing environment. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

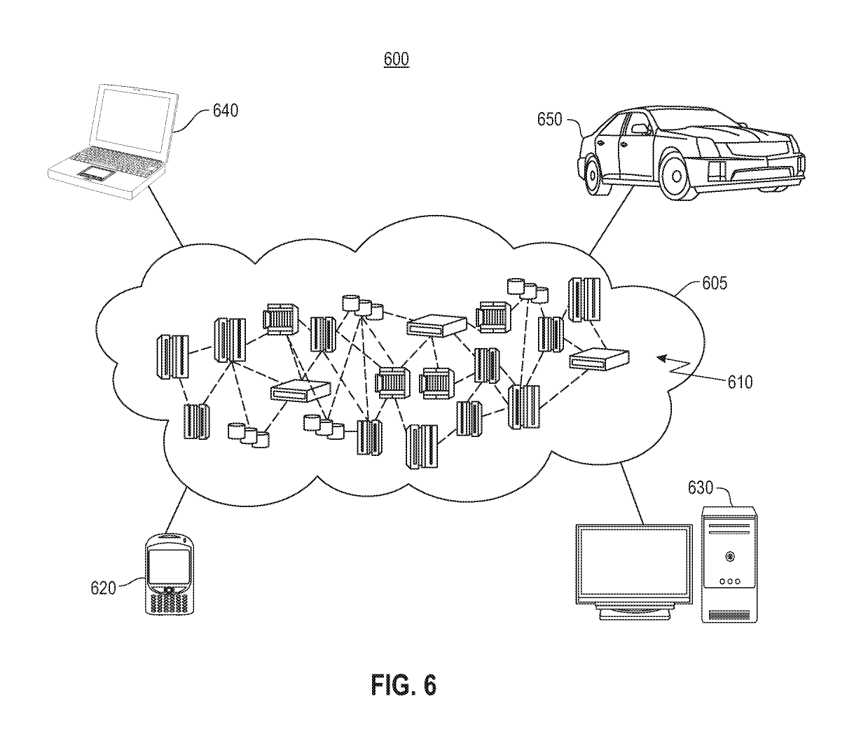

Referring now to FIG. 6, an illustrative cloud computing network (600) is shown. As shown, cloud computing network (600) includes a cloud computing environment (605) having one or more cloud computing nodes (610) with which local computing devices used by cloud consumers may communicate. Examples of these local computing devices include, but are not limited to, personal digital assistant (PDA) or cellular telephone (620), desktop computer (630), laptop computer (640), and/or automobile computer system (650). Individual nodes within nodes (610) may further communicate with one another. They may be grouped (not shown) physically or virtually, in one or more networks, such as Private, Community, Public, or Hybrid clouds as described hereinabove, or a combination thereof. This allows cloud computing environment (600) to offer infrastructure, platforms and/or software as services for which a cloud consumer does not need to maintain resources on a local computing device. It is understood that the types of computing devices (620)-(650) shown in FIG. 6 are intended to be illustrative only and that the cloud computing environment (605) can communicate with any type of computerized device over any type of network and/or network addressable connection (e.g., using a web browser).

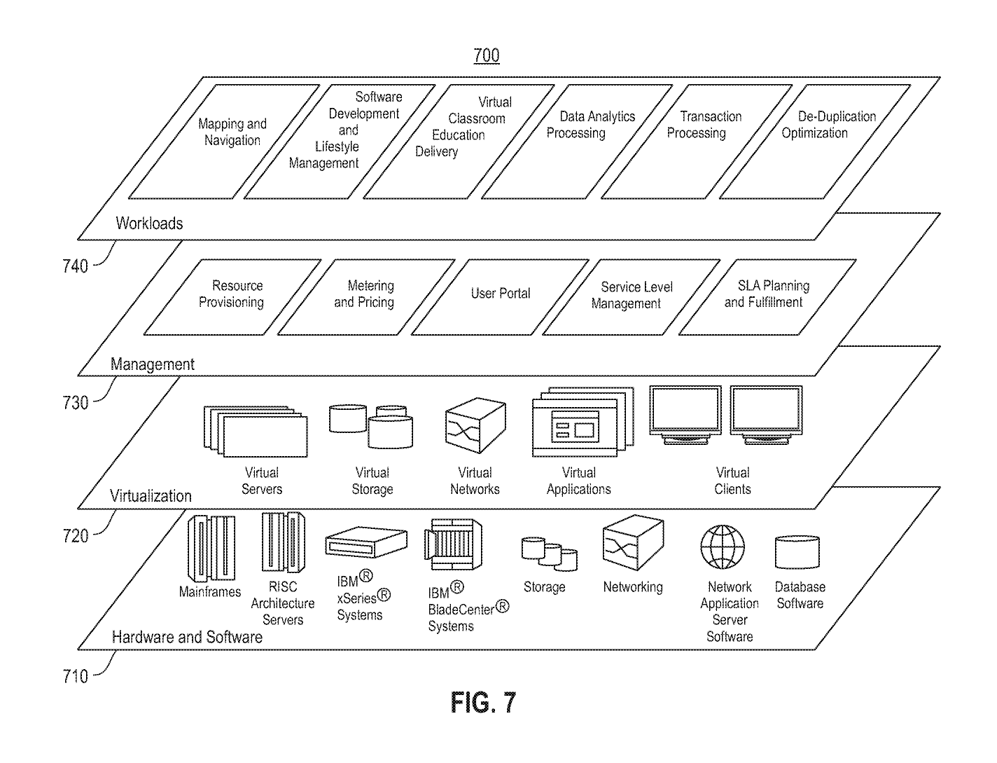

Referring now to FIG. 7, a set of functional abstraction layers provided by cloud computing network (600) is shown. It should be understood in advance that the components, layers, and functions shown in FIG. 7 are intended to be illustrative only, and the embodiments are not limited thereto. As depicted, the following layers and corresponding functions are provided: hardware and software layer (710), virtualization layer (720), management layer (730), and workload layer (740). The hardware and software layer (710) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (720) provides an abstraction layer from which the following examples of virtual entities may be provided: virtual servers; virtual storage; virtual networks, including virtual private networks; virtual applications and operating systems; and virtual clients.

In one example, management layer (730) may provide the following functions: resource provisioning, metering and pricing, user portal, service level management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer (740) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; and object storage support within the cloud computing environment.

The present invention may be a system, a method, and/or a computer program product. The computer program product may include a computer readable storage medium (or media) having computer readable program instructions thereon for causing a processor to carry out the aspects described herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the embodiments.

Aspects of the embodiments are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Accordingly, the a global content sharing graph supports optimization of an arrangement of cores within a de-duplication enabled shared-nothing clustered file system.

It will be appreciated that, although specific embodiments have been described herein for purposes of illustration, various modifications may be made without departing from the spirit and scope of the invention. Accordingly, the scope of protection is limited only by the following claims and their equivalents.

We claim:

1. A shared-nothing clustered file system comprising:
a processor in communication with memory; and
one or more tools in communication with the processor, the tools to:
scan metadata of the shared-nothing clustered file system;
locate one or more cores from the metadata, wherein each core comprises a grouping of objects having a minimum coreness;
optimize an arrangement of the located cores to improve global de-duplication efficiency, the optimization comprising:
evaluation of the objects of each core;
identification of respective nodes in the storage system to maintain each core for de-duplication efficiency based on the evaluation; and
re-arrangement of one or more of the evaluated objects in the storage system.

2. The system of claim 1, further comprising the one or more tools to create a global content sharing graph based on the scan, and employ the graph to locate the one or more cores.

3. The system of claim 1, wherein the re-arrangement further comprises the tools to migrate one or more objects between nodes of the file system.

4. The system of claim 1, further comprising the one or more tools to identify a new object from the scan, evaluate a coreness of the identified object, select a node assignment of the object responsive to the evaluated coreness, and assign the new object to the selected node, wherein the assignment optimizes the arrangement for de-duplication efficiency.

5. The system of claim 4, further comprising the tools to employ an inline probabilistic similarity estimation technique for locating an optimal node for placement of the new object, wherein the new object is assigned to the optimal node, and wherein the inline probabilistic similarity estimation technique utilizes a de-duplication map.

6. The system of claim 1, wherein the scanning of the repositories is an offline periodic scanning of one or more repositories of de-duplication metadata maintained local to respective nodes of the shared-nothing clustered file system.

7. A computer program product comprising a computer-readable storage medium having computer-readable program code embodied therewith, the program code executable by a processor to:
scan metadata of a shared-nothing clustered file system;
locate one or more cores from the metadata, wherein each core comprises a grouping of objects having a minimum coreness; and
optimize an arrangement of the located cores to improve global de-duplication efficiency, the optimization comprising program code to:
evaluate the objects of each core;
identify respective nodes in the storage system to maintain each core for de-duplication efficiency based on the evaluation; and
re-arrange one or more of the evaluated objects in the storage system.

8. The computer program product of claim 7, further comprising program code to create a global content sharing graph based on the scan, and employ the graph to locate the one or more cores.

9. The computer program product of claim 7, wherein the re-arrangement further comprises program code to migrate one or more objects between nodes of the storage system.

10. The computer program product of claim 7, further comprising program code to identify a new object from the scan, evaluate a coreness of the identified object, select a node assignment of the object responsive to the evaluated coreness, and assign the new object to the selected node, wherein the assignment optimizes the arrangement for de-duplication efficiency.

11. The computer program product of claim 10, further comprising program code to employ an inline probabilistic similarity estimation technique for locating an optimal node for placement of the new object, wherein the new object is assigned to the optimal node.

12. The computer program product of claim 11, wherein the inline probabilistic similarity estimation technique utilizes a de-duplication map.

13. The computer program product of claim 7, wherein the metadata comprises de-duplication metadata, and wherein the scanning of the repositories is an offline periodic scanning of one or more repositories of de-duplication metadata maintained local to respective nodes of the storage system.

14. A method comprising:
scanning metadata of a shared-nothing clustered file system;
locating one or more cores from the metadata, wherein each core comprises a grouping of objects having a minimum coreness; and
optimizing an arrangement of the located cores to improve global de-duplication efficiency, the optimization comprising:
evaluating the objects of each core;
identifying respective nodes in the storage system to maintain each core for de-duplication efficiency based on the evaluation; and
re-arranging one or more of the evaluated objects in the storage system.

15. The method of claim 14, further comprising creating a global content sharing graph based on the scan, and employing the graph to locate the one or more cores.

16. The method of claim 14, wherein the re-arrangement further comprises migrating one or more objects between nodes of the storage system.

17. The method of claim 14, further comprising identifying a new object from the scan, evaluating a coreness of the identified object, selecting a node assignment of the object responsive to the evaluated coreness, and assigning the new object to the selected node, wherein the assignment optimizes the arrangement for de-duplication efficiency.

18. The method of claim 17, further comprising employing an inline probabilistic similarity estimation technique for locating an optimal node for placement of the new object, wherein the new object is assigned to the optimal node.

19. The method of claim 18, wherein the inline probabilistic similarity estimation technique utilizes a de-duplication map.

20. The method of claim 14, wherein the metadata comprises de-duplication metadata, and wherein the scanning of the repositories is an offline periodic scanning of one or more repositories of de-duplication metadata maintained local to respective nodes of the storage system.
